(19) United States
(12) Patent Application Publication
(10) Pub. No.: US 2025/0102686 A1
(43) Pub. Date: Mar. 27, 2025

(54) CODOPED CESIUM IODIDE SCINTILLATORS

(71) Applicant: University of Tennessee Research Foundation, Knoxville, TN (US)

(72) Inventors: Everett Michael Cavanaugh, Knoxville, TN (US); Charles L. Melcher, Oak Ridge, TN (US); Kimberly Shay Pestovich, Knoxville, TN (US); Luis Manuel Stand Stracuzzi, Knoxville, TN (US)

(73) Assignee: University of Tennessee Research Foundation, Knoxville, TN (US)

(21) Appl. No.: 18/852,173

(22) PCT Filed: Mar. 31, 2023
(86) PCT No.: PCT/US23/17090

§ 371 Date: Sep. 27, 2024

Related U.S. Application Data
(60) Provisional application No. 63/325,933, filed on Mar. 31, 2022.

(51) Int. Cl. G01T 1/20; C09K 11/77

(52) U.S. Cl. CPC G01T 1/2006; C09K 11/7705

(57) ABSTRACT

Codoped sodium-doped cesium iodide scintillators are described. The codoping can alter one or more optical and/or scintillation property of the scintillator material. For example, the codoping can increase scintillation light yield and/or decrease scintillation decay time. Radiation detectors comprising the scintillators, methods of detecting high energy radiation using the radiation detectors, and methods of altering one or more scintillation and/or optical properties of a cesium iodide scintillator are also described.

### RELATED APPLICATIONS

This application claims priority to and the benefit of U.S. Provisional Patent Application Ser. No. 63/325,933, filed Mar. 31, 2022; the disclosure of which is incorporated herein by reference in its entirety.

### PARTIES TO A JOINT RESEARCH AGREEMENT

The subject matter disclosed herein was made by, on behalf of, and/or in connection with one or more of the following parties to a joint research agreement: Siemens Medical Solutions USA, Inc., and The University of Tennessee. The agreement was in effect on and before the effective filing date of the presently disclosed subject matter, and the presently disclosed subject matter was made as a result of activities undertaken within the scope of the agreement.

### TECHNICAL FIELD

The presently disclosed subject matter relates to methods of altering the optical and/or scintillation properties of sodium-doped cesium iodide scintillators and to sodium-doped cesium iodide scintillators that are codoped with mono- or divalent ions. The presently disclosed subject matter further relates to radiation detectors comprising the scintillator materials and to methods of using the scintillator materials to detect radiation.

### Abbreviations

%=percentage
° C.=degrees Celsius
at %=atomic percentage
Ca=calcium
Ce=cerium
cm=centimeters
cm⁻¹=inverse centimeters
Cs=cesium
CT=computed tomography
Cz=Czochralski
g=grams
keV=kiloelectron volts
LY=light yield
MeV=megaelectronvolt
Mg=magnesium
mm=millimeter
mol %=mole percent
Na=sodium
nm=nanometer
ns=nanoseconds
PET=positron emission tomography
ph=photons
PL=photoluminescence
PLE=photoluminescence excitation
pm=picometers
PMT=photomultiplier tube
ppm=parts-per-million
RL=radioluminescence
TL=thermoluminescence
TOF=time-of-flight
UV=ultraviolet

### BACKGROUND

Scintillator materials, which emit light pulses in response to impinging radiation, such as X-rays, gamma rays, and thermal neutron radiation, are used in detectors that have a wide range of applications in medical imaging, particle physics, geological exploration, security and other related areas. Considerations in selecting scintillator materials typically include, but are not limited to, luminosity, decay time, energy resolution, and emission wavelength.

While a variety of scintillator materials have been developed, there is an ongoing need to develop additional scintillator materials with improved properties for particular applications.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In some embodiments, the presently disclosed subject matter provides a scintillator material comprising a sodium-doped cesium iodide matrix, wherein said sodium-doped cesium iodide matrix is codoped with one or more codopant ions, wherein the one or more codopant ions are one or more monovalent cations, one or more divalent cations, or a combination of monovalent and divalent cations. In some embodiments, the one or more codopant ions are selected from monovalent and divalent cations of one or more elements of the group comprising K, Rb, Mg, Ca, Hg, Au, Zn, Sr, Ba, Pb, Sn, Sb, Sm, Eu, Tm, and Yb.

In some embodiments, the scintillator material has the formula:

Cs_{1-y-z}INa_{y}X_{z},

wherein: 0.0005≤y≤0.5; 0.00005≤z≤0.1; and X is one or more monovalent and/or divalent cations of one or more elements selected from the group comprising K, Rb, Mg, Ca, Hg, Au, Zn, Sr, Ba, Pb, Sn, Sb, Sm, Eu, Tm, and Yb. In some embodiments, X is one or more cation of one or more elements selected from Eu, Yb, Ca, Rb, Sr, and Sm. In some embodiments, X is one or more of Rb¹⁺ and Sm²⁺. In some embodiments, X is one or more of Ca²⁺ and Yb²⁺.

In some embodiments, 0.001≤y≤0.01, optionally wherein y is 0.003. In some embodiments, 0.0001≤z≤0.001.

In some embodiments, the scintillator material is selected from the group comprising CsI:Na,Eu (0.3%, 0.01%); CsI:Na,Eu (0.3%, 0.1%); CsI:Na, Yb (0.3%, 0.01%); CsI:Na, Yb (0.3%, 0.1%); CsI:Na, Ca (0.3%, 0.01%); CsI:Na, Rb (0.3%, 0.1%); CsI:Na, Rb (0.3%, 0.01%); CsI:Na,Sr (0.3%, 0.1%); CsI:Na, Sr (0.3%, 0.01%); CsI:Na, Sm (0.3%, 0.1%); and CsI:Na, Sm (0.3%, 0.01%).

In some embodiments, the scintillator material has an average light yield of more than 58,500 photons per megaelectronvolts (ph/MeV); optionally more than about 60,000 ph/MeV. In some embodiments, the scintillator material has decreased afterglow compared to the corresponding non-codoped Na-doped CsI scintillator material.

In some embodiments, the presently disclosed subject matter provides a radiation detector comprising a scintillator material and a photon detector, wherein said scintillator material is a scintillator material comprising a sodium-doped cesium iodide matrix, wherein said sodium-doped cesium iodide matrix is codoped with one or more codopant ions, wherein the one or more codopant ions are one or more monovalent cations, one or more divalent cations, or a combination of monovalent and divalent cations.

In some embodiments, the presently disclosed subject matter provides a method of detecting gamma rays, X-rays, cosmic rays, and/or particles having an energy of 1 keV or greater, the method comprising using a radiation detector as disclosed herein. In some embodiments, the presently disclosed subject matter provides for the use of radiation detector as disclosed herein in computed tomography, radiography, or high energy physics research.

In some embodiments, the presently disclosed subject matter provides a method of preparing a scintillator material, wherein the method comprises preparing the scintillator via the vertical Bridgman technique, optionally using a pulling rate of about 3 millimeters per hour (mm/h), and wherein the scintillator material is a scintillator material comprising a sodium-doped cesium iodide matrix, wherein said sodium-doped cesium iodide matrix is codoped with one or more codopant ions, wherein the one or more codopant ions are one or more monovalent cations, one or more divalent cations, or a combination of monovalent and divalent cations.

It is an object of the presently disclosed subject matter to provide codoped sodium-doped cesium iodide scintillators, radiation detectors comprising the codoped scintillator materials, methods of using the radiation detectors, and methods of altering the scintillator and/or optical properties of the scintillator materials.

An object of the presently disclosed subject matter having been stated hereinabove, and which is achieved in whole or in part by the presently disclosed subject matter, other objects will become evident upon a review of the description and as the description proceeds when taken in connection with the accompanying drawings and examples as best described herein below.

### BRIEF DESCRIPTION OF THE DRAWINGS

FIG. 1 is a photograph of crystal slabs of CsI:Na, Yb (0.3%, 0.01%) under white natural light.

FIG. 2 is a graph of the afterglow (intensity (presented as percent (%) maximum) versus time (in seconds(s))) for various codoped CsI:Na scintillators of the presently disclosed subject matter.

FIG. 3A is a graph of radioluminescence (normalized intensity versus emission wavelength) of Eu²⁺, Yb²⁺ (0.1%) and Sm²⁺ codoped CsI:Na.

FIG. 3B is a graph of radioluminescence (normalized intensity versus emission wavelength) of Sr²⁺, Ca²⁺ Rb⁺, Yb²⁺ (0.01%) codoped CsI:Na.

FIG. 4A is a graph of light yield (in photons (ph) per megaelectronvolt (MeV)) as a function of position along the boule for CsI:Na scintillators codoped with luminescent codopants (Eu, Yb, and Sm).

FIG. 4B is a graph of light yield (in photons (ph) per megaelectronvolt (MeV)) as a function of position along the boule for CsI:Na scintillators codoped with codopants that do not affect the radioluminescence spectra (Ca, Rb, and Sr).

FIG. 5 is a schematic drawing of an apparatus for detecting radiation according to the presently disclosed subject matter. Apparatus 10 includes photon detector 12 optically coupled to scintillator material 14. Apparatus 10 can optionally include electronics 16 for recording and/or displaying electronic signal from photon detector 12. Thus, optional electronics 16 can be in electronic communication with photon detector 12.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of time, temperature, light output, atomic (at) or mole (mol) percentage (%), and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

The term “scintillator” refers to a material that emits light (e.g., visible light) in response to stimulation by high energy radiation (e.g., X, α, β, or γ radiation).

The term “phosphor” as used herein refers to a material that emits light (e.g., visible light) in response to irradiation with electromagnetic or particle radiation.

In some embodiments, the compositional formula expression of an optical material (e.g., a scintillation material or a phosphor) can contain a colon “:” or comma, wherein the composition of the main or base matrix material (e.g., the main CsI matrix) is indicated on the left side of the colon or comma, and an activator (or dopant ion) or an activator and a codopant ion are indicated on the right side of the colon or comma. In some embodiments, the dopant (or dopant and codopant(s)) can replace all or part of the Cs in the CsI.

The term “high energy radiation” can refer to electromagnetic radiation having energy higher than that of ultraviolet radiation, including, but not limited to X radiation (i.e., X-ray radiation), alpha (α) particles, gamma (γ) radiation, and beta (β) radiation. In some embodiments, the high energy radiation refers to gamma rays, cosmic rays, X-rays, and/or particles having an energy of 1 keV or greater. Scintillator materials as described herein can be used as components of radiation detectors in apparatuses such as counters, image intensifiers, and computed tomography (CT) scanners.

“Optical coupling” as used herein refers to a physical coupling between a scintillator and a photosensor, e.g., via the presence of optical grease or another optical coupling compound (or index matching compound) that bridges the gap between the scintillator and the photosensor. In addition to optical grease, optical coupling compounds can include, for example, liquids, oils and gels.

“Light output” can refer to the number of light photons produced per unit energy deposited, e.g., by a gamma ray being absorbed, typically the number of light photons/MeV.

As used herein, chemical ions can be represented simply by their chemical element symbols alone (e.g., Eu for europium ion(s) (e.g., Eu²⁺) or Sm for samarium ion(s) (e.g., Sm²⁺)).

The term “rare earth element” as used herein refers to one or more elements selected from a lanthanide (e.g., lanthanum (La), cerium (Ce), Praseodymium (Pr), neodymium (Nd), promethium (Pm), samarium (Sm), europium (Eu), gadolinium (Gd), terbium (Tb), dysprosium (Dy), holmium (Ho) erbium (Er), thulium (Tm), ytterbium (Yb) and lutetium (Lu)), scandium (Sc), and yttrium (Y).

The term “transition metal element” as used herein refers to one or more elements selected from titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seborgium (Sg), bohrium (Bh), hassium (Hs), meitnerium (Mt), darmstadtium (Ds), roentgenium (Rg), and copernicium (Cn).

### II. Codoped Sodium-Doped Cesium Iodide Scintillators

The presently disclosed subject matter provides, in one aspect, a method for manufacturing a sodium doped cesium iodide scintillator with enhanced scintillation properties. Sodium doped cesium iodide scintillators with improved light yield and/or improved afterglow were produced by codoping with a divalent or monovalent cation. In some embodiments, the codoping formula is represented as follows: CsI:Na, X(Y % Z %), wherein X is either a divalent or monovalent codopant, Y is the molar percentage or atomic percentage of Na in the charge, and Z is the molar percentage or atomic percentage of the codopant in the charge. In some embodiments, the sodium doped cesium iodide scintillator is a material having the formula: Cs_{1-y-z}INa_{y}X_{z}, wherein: 0.0005≤y≤0.5; 0.00005≤z≤0.1; and X is one or more monovalent and/or divalent cations. The codopants include, but are not limited to, mono- and divalent cations of potassium (K), rubidium (Rb), magnesium (Mg), calcium (Ca), mercury (Hg), gold (Au), zinc (Zn), strontium (Sr), barium (Ba), lead (Pb), tin (Sn), antimony (Sb), samarium (Sm), europium (Eu), thulium (Tm), ytterbium (Yb), and mixtures thereof.

The improvement in afterglow and/or light yield of the CsI:Na provides or enhances the material's ability to be used in a wide range of radiation detection applications, such as, but not limited to, computed tomography (CT), radiography, and high energy physics.

Accordingly, in some embodiments, the presently disclosed subject matter provides a scintillator material comprising a sodium-doped cesium iodide matrix, wherein said sodium-doped cesium iodide matrix is codoped with one or more codopant ions. In some embodiments, the one or more codopant ions are one or more monovalent cations, one or more divalent cations, or a combination of monovalent and divalent cations. In some embodiments, the one or more codopant ions are selected from monovalent and divalent cations of one or more elements of the group comprising K, Rb, Mg, Ca, Hg, Au, Zn, Sr, Ba, Pb, Sn, Sb, Sm, Eu, Tm, and Yb.

In some embodiments, the scintillator material has the formula:

Cs_{1-y-z}INa_{y}X_{z},

wherein: 0.0005≤y≤0.5; 0.00005≤z≤0.1; and X is one or more monovalent and/or divalent cations of one or more elements (e.g., one, two, three, four or more elements) selected from the group comprising K, Rb, Mg, Ca, Hg, Au, Zn, Sr, Ba, Pb, Sn, Sb, Sm, Eu, Tm, and Yb. In some embodiments, X is one or more cation of one or more elements selected from Eu, Yb, Ca, Rb, Sr, and Sm. In some embodiments, X is one or more (i.e., one or both) of Rb¹⁺ and Sm²⁺. In some embodiments, X is one or more (i.e., one or both) of Ca²⁺ and Yb²⁺.

In some embodiments, 0.001≤y≤0.01. In some embodiments, y is 0.003 (i.e., about 0.3% of the Cs is replaced by Na).

In some embodiments, 0.0001≤z≤0.001. In some embodiments, z is 0.001 (i.e., about 0.1% of the Cs is replaced by X). In some embodiments z is 0.0001 (i.e., about 0.01% of the Cs is replaced by X).

In some embodiments, the scintillator material is selected from the group comprising: CsI:Na, Eu (0.3%, 0.01%); CsI:Na, Eu (0.3%, 0.1%); CsI:Na, Yb (0.3%, 0.01%); CsI:Na, Yb (0.3%, 0.1%); CsI:Na, Ca (0.3%, 0.01%); CsI:Na, Rb (0.3%, 0.1%); CsI:Na, Rb (0.3%, 0.01%); CsI:Na, Sr (0.3%, 0.1%); CsI:Na, Sr (0.3%, 0.01%); CsI:Na, Sm (0.3%, 0.1%); and CsI:Na, Sm (0.3%, 0.01%).

In some embodiments, the scintillator material has an average light yield of more than 58,500 photons per megaelectronvolts (ph/MeV). In some embodiments, the scintillator material has an average light yield of more than about 60,000 ph/MeV. In some embodiments, the scintillator material has decreased afterglow compared to the corresponding non-codoped Na-doped CsI scintillator material.

### III. Radiation Detectors, Related Devices and Methods

In some embodiments, the presently disclosed subject matter provides a radiation detector comprising a scintillator material as described hereinabove or a mixture of such materials. The radiation detector can comprise a scintillator (which absorbs radiation and emits light) and a photodetector (which detects said emitted light). The photodetector can be any suitable detector or detectors and can be or not be optically coupled to the scintillator material for producing an electrical signal in response to emission of light from the scintillator material. Thus, the photodetector can be configured to convert photons to an electrical signal. For example, a signal amplifier can be provided to convert an output signal from a photodiode into a voltage signal. The signal amplifier can also be designed to amplify the voltage signal. Electronics associated with the photodetector can be used to shape and digitize the electronic signal.

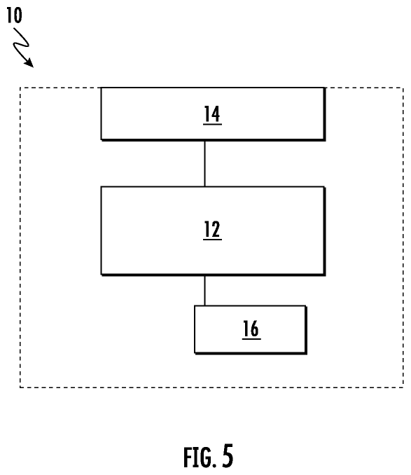

Referring now to FIG. 5, in some embodiments, the presently disclosed subject matter provides an apparatus 10 for detecting radiation wherein the apparatus comprises a photon detector 12 and a scintillator material 14 (e.g., a sodium-doped cesium iodide material codoped with one or more monovalent and/or divalent codopant ions). Scintillator material 14 can convert radiation to light that can be collected by a charge-coupled device (CCD) or a photomultiplier tube (PMT) or other photon detector 12 efficiently and at a fast rate.

Referring again to FIG. 5, photon detector 12 can be any suitable detector or detectors and can be optically coupled (e.g., via optical grease or another optical coupling compound, such as an optical coupling oil or liquid) to the scintillator (e.g., the tetravalent ion-codoped, europium-containing alkaline earth metal halide) for producing an electrical signal in response to emission of light from the scintillator. Thus, photon detector 12 can be configured to convert photons to an electrical signal. Electronics associated with photon detector 12 can be used to shape and digitize the electronic signal. Suitable photon detectors 12 include, but are not limited to, photomultiplier tubes, photodiodes, CCD sensors, and image intensifiers. Apparatus 10 can also include electronics 16 for recording and/or displaying the electronic signal.

In some embodiments, the radiation detector is configured for use as part of a medical or veterinary diagnostic device, a device for oil or other geological exploration (e.g., oil well logging probes), or as a device for security and/or military-related purposes (e.g., as a device for container, vehicle, or baggage scanning or for scanning humans or other animals). In some embodiments, the medical or veterinary diagnostic device is selected from, but not limited to, a positron emission tomography (PET) device, an X-ray computed tomography (CT) device, a radiography device, a single photon emission computed tomography (SPECT) device, or a planar nuclear medical imaging device. For example, the radiation detector can be configured to move (e.g., via mechanical and/or electronic controls) over and/or around a sample, such as a human or animal subject, such that it can detect radiation emitted from any desired site or sites on the sample. In some embodiments, the detector can be set or mounted on a rotating body to rotate the detector around a sample. In some embodiments, the radiation detector is configured for use in CT, radiography, or high energy physics research.

In some embodiments, the device can also include a radiation source. For instance, an X-ray CT device of the presently disclosed subject matter can include an X-ray source for radiating X-rays and a detector for detecting said X-rays. In some embodiments, the device can comprise a plurality of radiation detectors. The plurality of radiation detectors can be arranged, for example, in a cylindrical or other desired shape, for detecting radiation emitted from various positions on the surface of a sample.

In some embodiments, the presently disclosed subject matter provides a method for detecting radiation (or the absence of radiation) using a radiation detector comprising a sodium-doped cesium iodide scintillator codoped with one or more mono- and/or divalent codopant ions as described hereinabove. Thus, in some embodiments, the presently disclosed subject matter provides a method of detecting gamma rays, X-rays, cosmic rays and particles having an energy of 1 keV or greater, wherein the method comprises using a radiation detector comprising a scintillator material as disclosed herein or a mixture of such materials. In some embodiments, the method comprises using the radiation detector in computed tomography, radiography, or high energy physics research.

In some embodiments, the method can comprise providing a radiation detector comprising a photodetector and a scintillator material of the presently disclosed subject matter; positioning the detector, wherein the positioning comprises placing the detector in a location wherein the scintillator material is in the path of a beam of radiation (or the suspected path of a beam of radiation); and detecting light (or detecting the absence of light) emitted by the scintillator material with the photodetector. Detecting the light emitted by the scintillator material can comprise converting photons to an electrical signal. Detecting can also comprise processing the electrical signal to shape, digitize, or amplify the signal. The method can further comprise displaying the electrical signal or processed electrical signal.

In some embodiments, the presently disclosed subject matter provides for the use of a radiation detector comprising a photon detector and a scintillator material comprising a sodium-doped cesium iodide scintillator codoped with one or more mono- and/or divalent codopant ions as described hereinabove. In some embodiments, the use is for medical or veterinary diagnostics (e.g., the radiation detector is configured for use in medical or veterinary diagnostics). In some embodiments, the use is in computed tomography, radiography, or high energy physics research.

### IV. Methods of Preparation of Scintillation Materials

The presently disclosed scintillation materials can be prepared via any suitable method. Typically, the appropriate reactants (e.g., CsI, NaI, and one or more additional metal iodides, such as, but not limited to SrI₂, CaI₂, EuI₂, KI, and the like) are melted at a temperature sufficient to form a congruent, molten composition. The melting temperature can depend on the identity of the reactants themselves (e.g., on the melting points of the individual reactants), but is usually in the range of from about 300° C. to about 1350° C. Exemplary techniques for preparing the materials include, but are not limited to, the Bridgman or Bridgman-Stockbarger method, the Czochralski method, the zone-melting method (or “floating zone” method), the vertical gradient freeze (VGF) method, and temperature gradient methods.

For instance, in some embodiments, high purity reactants can be mixed and melted to synthesize a compound of the desired composition. A single crystal or polycrystalline material can be grown from the synthesized compound by the Bridgman method, in which a sealed ampoule containing the synthesized compound is transported from a hot zone to a cold zone through a controlled temperature gradient at a controlled speed (i.e., a “pulling rate”). In some embodiments, high purity reactants can be mixed in stoichiometric ratios depending upon the desired composition of the scintillator material and loaded into an ampoule, which is then sealed. After sealing, the ampoule is heated and then cooled at a controlled speed. In some embodiments, a scintillator of the presently disclosed subject matter is prepared via the vertical Bridgman technique. In some embodiments, the pulling (or translation) rate used in preparing scintillator crystals via the Bridgman technique is about 0.1 millimeters per hour (mm/hr) to about 5 mm/hr (e.g., about 0.1 mm/hr; about 0.5 mm/hr, about 1 mm/hr, about 2 mm/hr, about 3 mm/hr, about 4 mm/hr, or about 5 mm/hr). In some embodiments, the method comprises using a pulling rate of about 3 mm/h.

In some embodiments, the presently disclosed subject matter provides a method of preparing a scintillation material comprising a sodium-doped cesium iodide codoped with one or more mono- and/or divalent codopant ions described hereinabove. In some embodiments, the method comprises heating a mixture of raw materials (e.g., a mixture of metal iodides in a stoichiometric ratio depending upon the formula of the desired scintillation material) above their respective melting temperatures (i.e., above the melting temperature of the raw material with the highest melting temperature). In some embodiments, the raw materials are dried prior to, during, or after mixing. In some embodiments, the raw materials are mixed under low humidity and/or low oxygen conditions. In some embodiments, the raw materials are mixed in a dry box and/or under conditions of less than about 0.1 parts-per-million (ppm) moisture and/or oxygen (e.g., less than about 0.1 ppm, less than about 0.09 ppm, less than about 0.08 ppm, less than about 0.07 ppm, less than about 0.06 ppm, less than about 0.05 ppm, less than about 0.04 ppm, less than about 0.03 ppm, less than about 0.02 ppm, or less than about 0.01 ppm moisture and/or oxygen).

The mixture of raw materials can be sealed in a container (e.g., a quartz ampoule) that can withstand the subsequent heating of the mixture and which is chemically inert to the mixture of raw materials. The mixture can be heated at a predetermined rate to a temperature above the melting temperature of the individual raw materials. In some embodiments, the mixture can be heated to a temperature that is between about 10° C. and about 50° C. (e.g., about 10° C., about 12° C., about 14° C., about 16° C., about 18° C., about 20° C., about 22° C., about 24° C., about 26° C., about 28° C., about 30° C., about 32° C., about 34° C., about 36° C., about 38° C., about 40° C., about 42° C., about 44° C., about 46° C., about 48° C., or about 50° C.) above the melting temperature of the raw material with the highest melting temperature. In some embodiments, the mixture is heated to about 50° C. above the melting temperature of the raw material with the highest melting temperature. This temperature can be maintained for a period of time, such as between about 2 and about 36 hours (e.g., about 2, about 3, about 4, about 5, about 6, about 7, about 8, about 9, about 10, about 11, about 12, about 14, about 16, about 18, about 20, about 22, about 24, about 26, about 28, about 30, about 32, about 34, or about 36 hours). In some embodiments, the temperature is maintained for about 24 hours. Then the mixture can be cooled at a predetermined rate until the mixture reaches about room temperature (e.g., between about 20° C. and about 25° C.). If desired, the sealed container can be rotated or inverted. In some embodiments, the heating and cooling can be repeated, e.g., to provide further mixing of all of the components in the mixture. The rotating or inverting and heating/cooling steps can be repeated one or more additional times, as desired.

In some embodiments, the method further comprises a post-growth annealing step. Thus, in some embodiments, the method further comprises annealing the scintillator material. The annealing can be performed, for example, in air, nitrogen, or a mixture of nitrogen and hydrogen. The annealing can be done at any suitable temperature below the melting point of the scintillator, e.g., between about 100° C. and about 1600° C. (e.g., about 100° C., about 200° C., about 300° C., about 400° C., about 500° C., about 600° C., about 700° C., about 800° C., about 900° C., about 1000° C., about 1100° C., about 1200° C., about 1300° C., about 1400° C., about 1500° C., and about 1600° C.).

In some embodiments, the scintillation materials can be provided as single crystals, as a polycrystalline material, and/or as a ceramic material. In some embodiments, the material is provided as a polycrystalline material. The polycrystalline material can have analogous physical, optical and scintillation properties as a single crystal otherwise having the same chemical composition.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

Exemplary codoped CsI:Na scintillators include, but are not limited to, the compositions listed in Table 1, below. These crystals were grown via the vertical Bridgman method, and their scintillation properties are presented below. High purity CsI beads, NaI beads, and codopant iodides were loaded into a 12 mm inner diameter carbon coated ampoule while in a low oxygen, low H₂O content glovebox. Once loaded, the ampoules were transferred to a vacuum station where the ampoule was brought under vacuum, and the material was heated at about 250° C. for about 4 hours. The ampoules were then sealed using a hydrogen-oxygen torch, and then placed in a quartz boat within a three-zone furnace for growth. The ampoule was gradually heated to a temperature that is about 50° C. higher than the highest melting point of all constituents. The melted materials were mixed for a period of about 24 hours. Once mixed, the hot zone of the furnace was lowered to about 680° C., and the bottom zone was set to 450° C. The growths proceeded with a translation speed of 3 mm per hour. After translating the length of the crystal, the ampoule was cooled over about 24 hours. The crystals were extracted from the ampoule and cut into 12 mm diameter, 4 mm thick slabs. The slabs were polished prior to characterization. The resulting crystals were transparent and crack free. Large sections of the crystal are free of any visible impurities, with the exception of the last-to-freeze regions.

### Crystal Growth of CsI:Na, X Crystals:

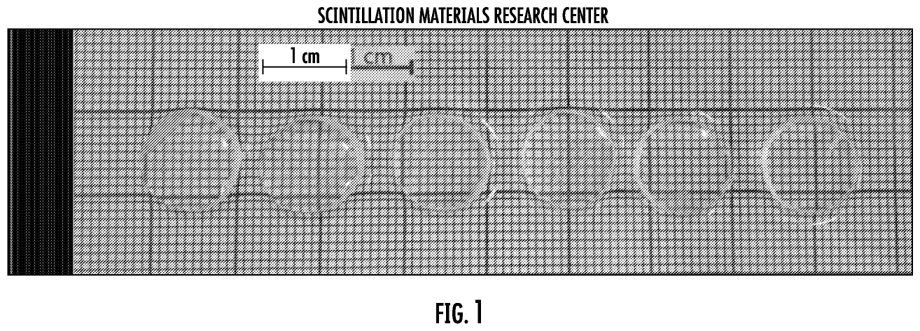

Codoped CsI:Na crystals were grown by the vertical Bridgman method with a translation rate of about 3 mm per hour. FIG. 1 is a photograph of a typical example of crystal quality of the codoped CsI:Na scintillators. The crystals are of good optical quality with little to no visible defects in the crystals.

### Afterglow:

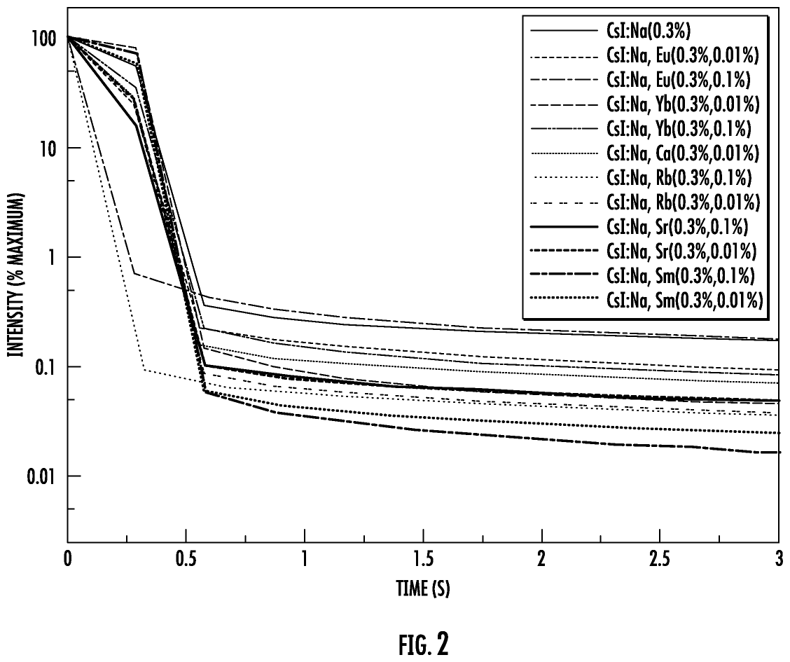

Afterglow measurements were made by irradiating samples with an X-ray tube operated at approximately 36 kV and 0.2 mA for approximately 15 minutes. A photomultiplier tube (PMT) operating in current mode was used to measure the light emitted by the sample as a function of time. Samples were coupled to the PMT with a thin layer of optical grease. The tube voltage is set such that the signal from the PMT rests just below saturation for each sample to account for differences in sample light yield. The intensity of the signal is plotted against time, and the samples are compared to an in-house grown reference CsI:Na sample. The afterglow profiles are shown in FIG. 2.

### Radioluminescence:

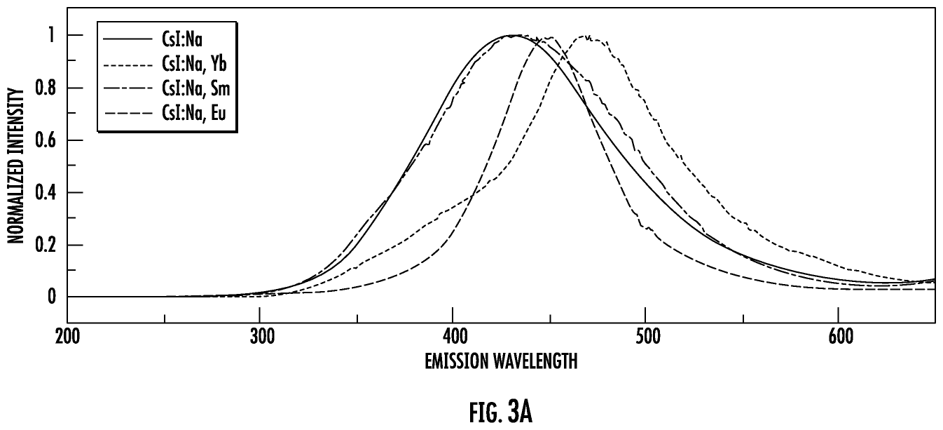

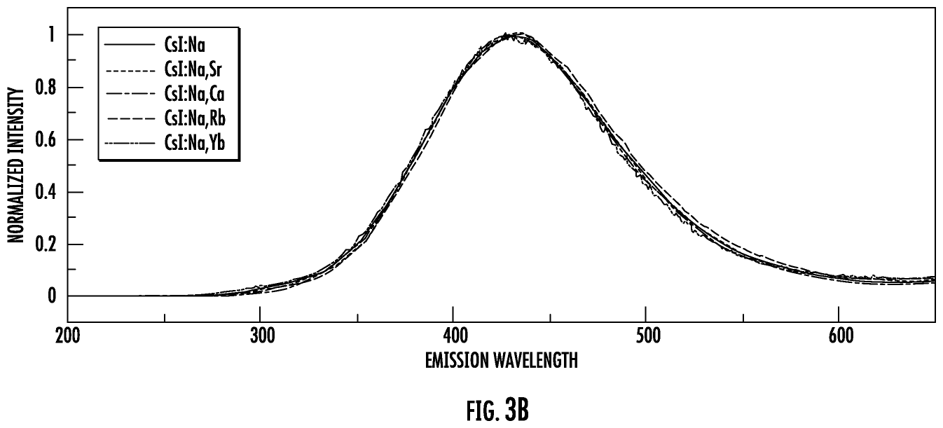

Radioluminescence spectra were measured at room temperature under continuous irradiation from an X-ray generator model (CMX003 (35 KV and 0.1 mA). A model PI Acton Spectra Pro SP-2155 monochromator was used to record the spectra. Eu²⁺, Rb¹⁺, and Sm²⁺ codoped samples demonstrated evidence of luminescent energy transfer between the primary luminescence center (Na) and the codopant. In FIG. 3A, shifted radioluminescence peaks indicate such energy transfers. The results of the radioluminescence measurements are shown in FIGS. 3A and 3B.

### Response to γ-Ray Excitation:

Light output measurements were performed. Crystal slabs were polished with a 1200 grit polishing pad before loading into a Teflon-wrapped quartz housing filled with mineral oil. The sample was centered inside the housing, and the housing was coupled to a Hamamatsu R2059 with a thin layer of mineral oil. Layers of Teflon tapes were added to shroud the open face of the holder and PMT. The sample was excited with a cesium-137 source. The PMT was supplied with 1500 V bias, with signal fed into a shaping amplifier and then a spectroscopic amplifier with a shaping time of 10 μs, a coarse gain of 5, and a fine gain of 0.5. The integral quantum efficiency of the PMT was used in conjunction with the radioluminescence spectra of the scintillator to calculate an absolute light yield in photons per MeV.

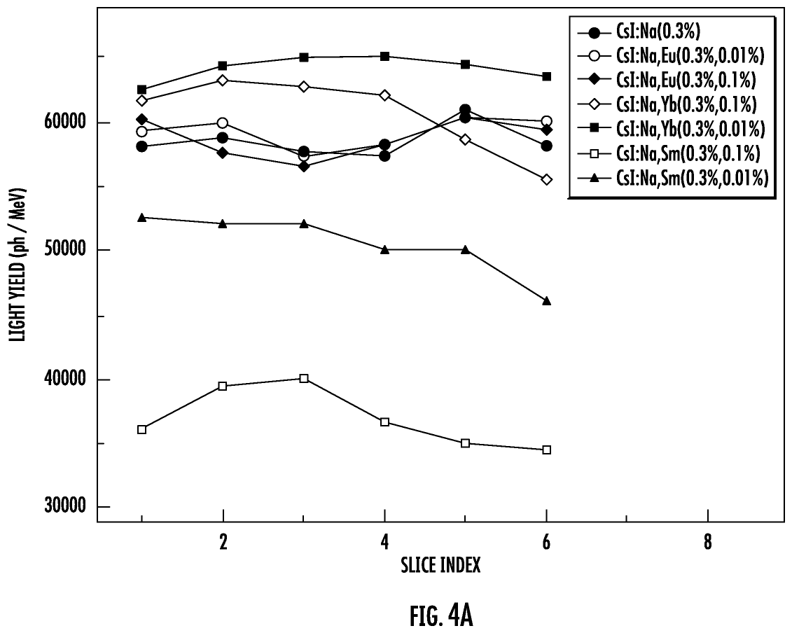

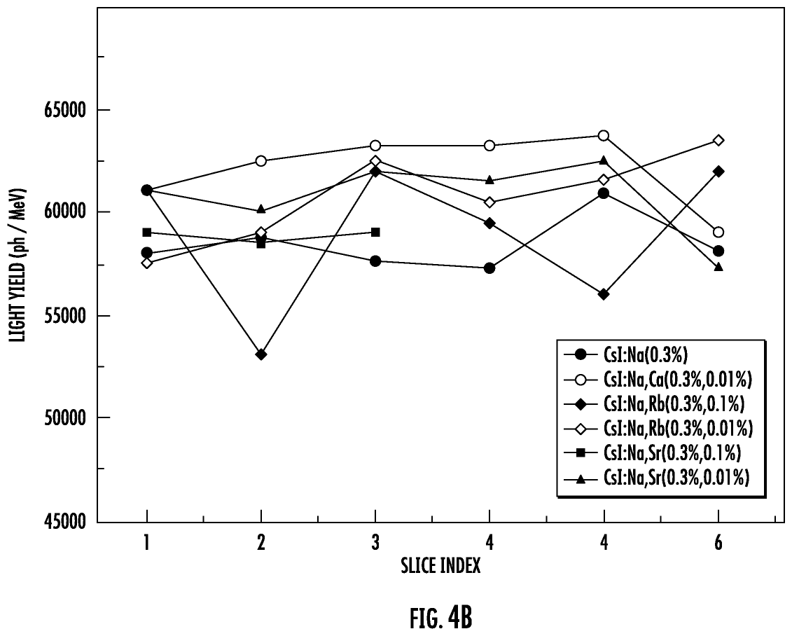

Each codoped CsI:Na crystal was cut into 6 slabs, from seed end to tail end of the crystal. Light yield of each slab was measured and plotted against their position in the crystal boules. These measurements serve as a measure of absolute light output and dopant/codopant uniformity. This is shown in FIGS. 4A and 4B.

### Summary of Properties:

A summary of measured properties is provided in Table 1, below. Light yield is reported as the averaged light yield of all scintillator slabs. Decay time is measured using the Bollinger Thomas decay time set up and fit using a two-component exponential. See Bollinger, Review of Scientific Instruments, Vol. 32, p. 7 (1961).

TABLE 1
Summary of Scintillation Properties Measured
for CsI:Na and codoped CsI:Na.

| | | | | Afterglow |
|---|---|---|---|---|
| | | | | (unitless, |
| | Light Yield | | Peak | presented as |
| | (ph/MeV) | Decay | Emission | a percentage |
| | (average | Constants | Wavelength | of maximum |
| Composition | over slices | (ns) | (nm) | intensity) |
| CsI:Na (0.3%) | 58,500 | 546 | 430 | 0.27 |
| | | (80.06%), | | |
| | | 4055 | | |
| | | (19.94%) | | |
| CsI:Na, Eu | 58,700 | 578 | 450 | 0.28 |
| (0.3%, 0.1%) | | (82.17%), | | |
| | | 3894 | | |
| | | (17.83%) | | |
| CsI:Na, Eu | 59,100 | 673 | 450 | 0.15 |
| (0.3%, 0.01%) | | (43.16%), | | |
| | | 2609 | | |
| | | (56.84%) | | |
| CsI:Na, Yb | 60,500 | 540 | 470 | 0.15 |
| (0.3%, 0.1%) | | (36.62%), | | |
| | | 3885 | | |
| | | (63.38%) | | |
| CsI:Na, Yb | 64,100 | 541 | 430 | 0.08 |
| (0.3%, 0.01%) | | (35.8%), | | |
| | | 3845 | | |
| | | (64.20%) | | |
| CsI:Na, Ca | 62,100 | 517 | 430 | 0.11 |
| (0.3%, 0.01%) | | (40.09%) | | |
| | | 3745 | | |
| | | (59.91%) | | |
| CsI:Na, Sr | 58,700 | 580 | 430 | 0.08 |
| (0.3%, 0.1%) | | (13.19%) | | |
| | | 3998 | | |
| | | (86.81%) | | |
| CsI:Na, Sr | 60,700 | 484 | 430 | 0.08 |
| (0.3%, 0.01%) | | (8.19%), | | |
| | | 3379 | | |
| | | (91.81%) | | |
| CsI:Na, Sm | 36,900 | 576 | 430 | 0.03 |
| (0.3%, 0.1%) | | (35.25%), | | |
| | | 4029 | | |
| | | (64.75%) | | |
| CsI:Na, Sm | 50,400 | 542 | 430 | 0.04 |
| (0.3%, 0.01%) | | (37.79%), | | |
| | | 3740 | | |
| | | (62.21%) | | |
| CsI:Na, Rb | 58,900 | 580 | 430 | 0.06 |
| (0.3%, 0.1%) | | (33.16%), | | |
| | | 4114 | | |
| | | (66.84%) | | |
| CsI:Na, Rb | 60,700 | 560 | 430 | 0.06 |
| (0.3%, 0.01%) | | (11.25%), | | |
| | | 3948 | | |
| | | (88.77%) | | |

### CONCLUSION

The scintillation properties of CsI:Na were modified by codoping with divalent or monovalent codopants. The above examples demonstrate some alterations of the scintillation properties of CsI:Na through codoping. A CsI:Na 0.3% crystal was grown and characterized for comparison. Of note is the improvement of light yield by Ca²⁺ and Yb²⁺ codoping and improvement of afterglow suppression by Sm²⁺ and Rb¹⁺ codoping. The examples presented herein are representative of the presently disclosed subject matter, which extends to include any of the listed codopants by themselves or in combination with one another.

It will be understood that various details of the presently disclosed subject matter may be changed without departing from the scope of the presently disclosed subject matter. Furthermore, the foregoing description is for the purpose of illustration only, and not for the purpose of limitation.

1. A scintillator material comprising a sodium-doped cesium iodide matrix, wherein said sodium-doped cesium iodide matrix is codoped with one or more codopant ions, wherein the one or more codopant ions are one or more monovalent cations, one or more divalent cations, or a combination of monovalent and divalent cations.

2. The scintillator material of claim 1, wherein the one or more codopant ions are selected from monovalent and divalent cations of one or more elements of the group consisting of K, Rb, Mg, Ca, Hg, Au, Zn, Sr, Ba, Pb, Sn, Sb, Sm, Eu, Tm, and Yb.

3. The scintillator material of claim 1, wherein the scintillator material has the formula:
Cs_{1-y-z}INa_{y}X_{z},
wherein:
$$\begin{matrix}0.0005 \leq y \leq 0.5 ; \\ 0.00005 \leq z \leq 0.1 ;\end{matrix}$$
and
X is one or more monovalent and/or divalent cations of one or more elements selected from the group consisting of K, Rb, Mg, Ca, Hg, Au, Zn, Sr, Ba, Pb, Sn, Sb, Sm, Eu, Tm, and Yb.

4. The scintillator material of claim 3, wherein X is one or more cation of one or more elements selected from Eu, Yb, Ca, Rb, Sr, and Sm.

5. The scintillator material of claim 4, wherein X is one or more of Rb¹⁺ and Sm²⁺.

6. The scintillator material of claim 4, wherein X is one or more of Ca²⁺ and Yb²⁺.

7. The scintillator material of claim 3, wherein 0.001≤y≤0.01, optionally wherein y is 0.003.

8. The scintillator material of claim 3, wherein 0.0001≤z≤0.001.

9. The scintillator material of claim 1, wherein the scintillator material is selected from the group consisting of CsI:Na, Eu (0.3%, 0.01%); CsI:Na, Eu (0.3%, 0.1%); CsI:Na, Yb (0.3%, 0.01%); CsI:Na, Rb (0.3%, 0.1%); CsI:Na, Sr (0.3%, 0.01%); CsI:Na, Yb (0.3%, 0.1%); CsI:Na, Ca (0.3%, 0.01%); CsI:Na, Rb (0.3%, 0.01%); CsI:Na, Sr (0.3%, 0.1%); CsI:Na, Sm (0.3%, 0.1%); and CsI:Na, Sm (0.3%, 0.01%).

10. The scintillator material of claim 1, wherein the scintillator material has an average light yield of more than 58,500 photons per megaelectronvolts (ph/MeV); optionally more than about 60,000 ph/MeV.

11. The scintillator material of claim 1, wherein the scintillator material has decreased afterglow compared to the corresponding non-codoped Na-doped CsI scintillator material.

12. A radiation detector comprising a scintillator material of claim 1 and a photon detector.

13. A method of detecting gamma rays, X-rays, cosmic rays, and/or particles having an energy of 1 keV or greater, the method comprising using the radiation detector of claim 12.

14. Use of a radiation detector of claim 12 in computed tomography, radiography, or high energy physics research.

15. A method of preparing a scintillator material of claim 1, wherein the method comprises preparing the scintillator via the vertical Bridgman technique, optionally using a pulling rate of about 3 millimeters per hour (mm/h).
